(19) United States
(12) Patent Application Publication
(10) Pub. No.: US 2026/0169875 A1
(43) Pub. Date: Jun. 18, 2026

(54) CXL FAIL VISIBILITY MODE

(71) Applicant: Micron Technology, Inc., Boise, ID (US)

(72) Inventors: Garth N. Grubb, Boise, ID (US); Sujeet Ayyapureddi, Boise, ID (US); Senthil Murugan Thangaraj, Fremont, CA (US); Su Wei Lim, Bayan Lepas (MY)

(21) Appl. No.: 18/982,874

(22) Filed: Dec. 16, 2024

(51) Int. Cl. G06F 11/22

(52) U.S. Cl. CPC G06F 11/2268

(57) ABSTRACT

Devices and techniques that provide a fail visibility in a memory device are described herein. A memory system includes a first non-volatile memory to store error data; a second memory to store failure data; a random access memory device; and controller circuitry configured to: set a test mode in the random access memory device; read a row from a memory array of the random access memory device, the row including data bits and parity bits; use the parity bits to identify an error in the data bits; store an indication of the error in the first non-volatile memory; and store an indication of accumulated errors in the second memory.

### BACKGROUND

Memory devices are typically provided as internal, semiconductor, integrated circuits in computers or other electronic devices. There are many diverse types of memory including volatile and non-volatile memory. Volatile memory can require power to maintain data and includes random-access memory (RAM), dynamic random-access memory (DRAM), and synchronous dynamic random-access memory (SDRAM), among others. Non-volatile memory can provide persistent data by retaining stored data when not powered and can include NAND flash memory, NOR flash memory, read only memory (ROM), Electrically Erasable Programmable ROM (EEPROM), Erasable Programmable ROM (EPROM), and resistance variable memory such as phase change random access memory (PCRAM), resistive random-access memory (RRAM), and magnetoresistive random access memory (MRAM), 3D XPoint™ memory, among others.

Memory devices may be coupled to a host (e.g., a host computing device) to store data, commands, and/or instructions for use by the host while the computer or electronic system is operating. For example, data, commands, and/or instructions can be transferred between the host and the memory device(s) during operation of a computing or other electronic system.

Various protocols or standards can be applied to facilitate communication between a host and one or more other devices (e.g., memory buffers, accelerators, or other input/output devices). In an example, an unordered protocol such as Compute Express Link (CXL) can be used to provide high-bandwidth and low-latency connectivity.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

To easily identify the discussion of any particular element or act, the most significant digit or digits in a reference number refer to the figure number in which that element is first introduced.

FIG. 1 is a block diagram illustrating an example of a computing system including a host device and a memory system, according to an embodiment.

FIG. 2 is a block diagram illustrating an example of a CXL system that uses a bus system, including a CXL link bus and a system management bus (SMBus), to connect a host device and a CXL device, according to an embodiment.

FIG. 3 illustrates an example of an environment including a host device and a memory device configured to communicate over a communication interface, according to an embodiment.

FIG. 4 is a schematic of an electrical arrangement of components of an embodiment of an example DRAM device, according to an embodiment.

FIG. 5 shows an example of sensing circuitry for the respective columns including differential sense amplifiers (DSA) and multiplexers (MUXs), according to an embodiment.

FIG. 6 is a block diagram illustrating a system architecture for error correction on a CXL device, according to an embodiment.

FIG. 7 is a flowchart illustrating a method for fail logging of a memory array, according to an embodiment.

FIG. 8 is a flowchart illustrating a method for fail logging of a memory array, according to an embodiment.

FIG. 9 is a flowchart illustrating an example method for collecting fail data, according to an embodiment.

FIG. 10 illustrates a block diagram of an example machine with which, in which, or by which any one or more of the techniques (e.g., methodologies) discussed herein can be implemented.

### DETAILED DESCRIPTION

Aspects of the present disclosure are directed to detecting bit error trends in memory devices. The memory devices may be integrated or incorporated into a peripheral device, such as a Compute Express Link device. Compute Express Link (CXL) is an open standard interconnect configured for high-bandwidth, low-latency connectivity between host devices and other devices such as accelerators, memory buffers, and other I/O devices. CXL was designed to facilitate high-performance computational workloads by supporting heterogeneous processing and memory systems. CXL enables coherency and memory semantics on top of PCI Express (PCIe)-based I/O semantics for optimized performance.

In some examples, CXL is used in applications such as artificial intelligence, machine learning, analytics, cloud infrastructure, edge computing devices, communication systems, and elsewhere. Data processing in such applications can use various scalar, vector, matrix, and spatial architectures that can be deployed in CPU, GPU, FPGA, smart NICs, or other accelerators that can be coupled using a CXL link.

CXL supports dynamic multiplexing using a set of protocols that includes input/output (CXL.io, based on PCIe), caching (CXL.cache), and memory (CXL.memory or CXL.mem) semantics. In an example, CXL can be used to maintain a unified, coherent memory space between the CPU (e.g., a host device or host processor) and any memory on the attached CXL device. This configuration allows the CPU and the CXL device to share resources and operate on the same memory region for higher performance, reduced data movement, and reduced software stack complexity. In an example, the CPU is primarily responsible for maintaining or managing coherency in a CXL environment. Accordingly, CXL can be leveraged to help reduce device cost and complexity, as well as overhead traditionally associated with coherency across an I/O link.

CXL runs on PCIe PHY and provides full interoperability with PCIe. In an example, a CXL device starts link training in a PCIe Gen 1 Data Rate and negotiates CXL as its operating protocol (e.g., using the alternate protocol negotiation mechanism defined in the PCIe 5.0 Specification) if its link partner supports CXL. Devices and platforms can thus more readily adopt CXL by leveraging the PCIe infrastructure without having to design and validate the PHY, channel, channel extension devices, or other upper layers of PCIe.

In an example, CXL supports single-level switching to enable fan-out to multiple devices. This enables multiple devices in a platform to migrate to CXL, while maintaining backward compatibility and the low-latency characteristics of CXL. In an example, CXL can provide a standardized compute fabric that supports pooling of multiple logical devices (MLD) and single logical devices such as using a CXL switch connected to several host devices or nodes (e.g., Root Ports). This feature enables servers to pool resources such as accelerators and/or memory that can be assigned according to workload. For example, CXL can help facilitate resource allocation or dedication and release. In an example, CXL can help allocate and deallocate memory to various host devices according to need. This flexibility helps designers avoid over-provisioning while ensuring best performance.

CXL devices include one or more memory devices, each of which may include its own error correction code (ECC) circuitry to track and handle bit errors that occur in memory cells of the memory devices. These on-die error correction circuitry generally corrects errors when data is read and information about the errors (e.g., error rate, memory cell/row that was affected, etc.) are hidden from the customer. What is needed is a mechanism to provide additional error information about error rate, memory cell condition, row defects, etc. This information is useful to perform various remedial actions, such as post package repair, off-lining pages of memory, alerting hardware, software, or humans about errors, and the like.

The systems and methods described herein provide for an improved CXL device that tracks ECC bits and performs actions based on error data. The CXL device can use customized memory, storage, and compute to provide fail tracking and improve detection and reaction time for handling errors. A test mode is used to gather parity data during a memory operation. This test mode, which is typically disabled, can be used on CXL devices because the CXL device exists in a security realm isolated from the host. Additional details are set forth below.

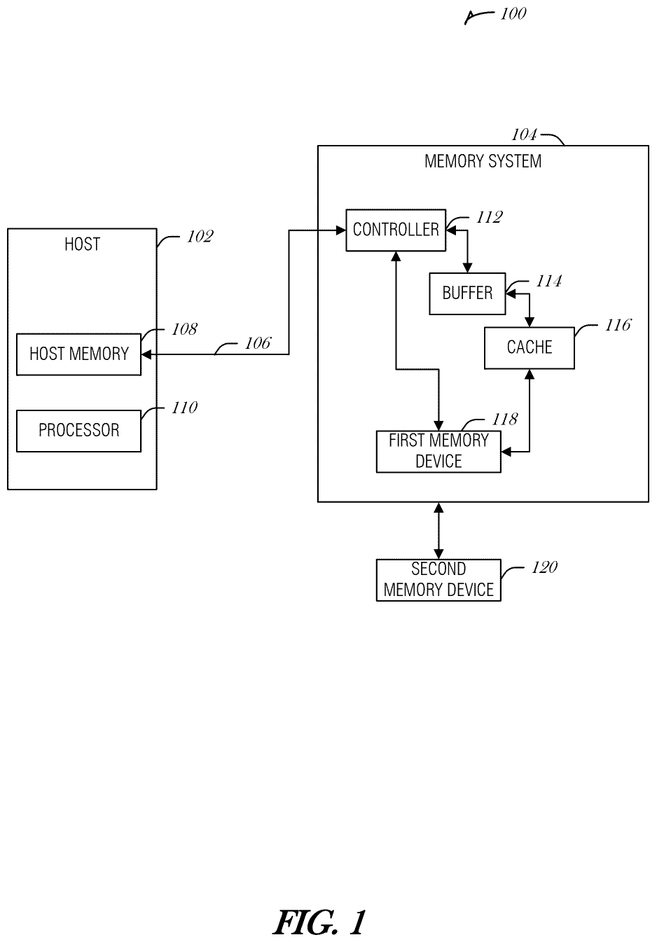

FIG. 1 is a block diagram illustrating an example of a computing system 100 including a host device 102 and a memory system 104, according to an embodiment. The host device 102 includes a central processing unit (CPU) or processor 110 and a host memory 108. In an example, the host device 102 can include a host system such as a personal computer, a desktop computer, a digital camera, a smart phone, a memory card reader, and/or Internet-of-things enabled device, among various other types of hosts, and can include a memory access device, e.g., the processor 110. The processor 110 can include one or more processor cores, a system of parallel processors, or other CPU arrangement.

The memory system 104 includes a controller 112, a buffer 114, a cache 116, and a first memory device 118. The first memory device 118 can include, for example, one or more memory modules (e.g., single in-line memory modules, dual in-line memory modules, etc.). The first memory device 118 can include volatile memory and/or non-volatile memory, and can include a multiple-chip device that comprises one or multiple different memory types or modules. In an example, the computing system 100 includes a second memory device 120 that interfaces with the memory system 104 and the host device 102.

The host device 102 can include a system backplane and can include a number of processing resources (e.g., one or more processors, microprocessors, or some other type of controlling circuitry). The computing system 100 can optionally include separate integrated circuits for the host device 102, the memory system 104, the controller 112, the buffer 114, the cache 116, the first memory device 118, the second memory device 120, any one or more of which may comprise respective chiplets that can be connected and used together. In an example, the computing system 100 includes a server system and/or a high-performance computing (HPC) system and/or a portion thereof. Although the example shown in FIG. 1 illustrates a system having a Von Neumann architecture, embodiments of the present disclosure can be implemented in non-Von Neumann architectures, which may not include one or more components (e.g., CPU, ALU, etc.) often associated with a Von Neumann architecture.

In an example, the first memory device 118 can provide a main memory for the computing system 100, or the first memory device 118 can comprise accessory memory or storage for use by the computing system 100. In an example, the first memory device 118 or the second memory device 120 includes one or more arrays of memory cells, e.g., volatile and/or non-volatile memory cells. The arrays can be flash arrays with a NAND architecture with 2D or 3D architecture, for example. Embodiments are not limited to a particular type of memory device. For instance, the memory devices can include RAM, ROM, DRAM, SDRAM, PCRAM, RRAM, flash memory, among others that can use 2D or 3D architectures.

In embodiments in which the first memory device 118 includes persistent or non-volatile memory, the first memory device 118 can include a flash memory device such as a NAND or NOR flash memory device. The first memory device 118 can include other non-volatile memory devices such as non-volatile random-access memory devices (e.g., NVRAM, ReRAM, FeRAM, MRAM, PCM), memory devices such as a ferroelectric RAM device that includes ferroelectric capacitors that can exhibit hysteresis characteristics, a 3-D Crosspoint (3D XP) memory device, etc., or combinations thereof.

In an example, the controller 112 comprises a media controller such as a non-volatile memory express (NVMe) controller. The controller 112 can be configured to perform operations such as copy, write, read, error correct, etc. for the first memory device 118. In an example, the controller 112 can include purpose-built circuitry and/or instructions to perform various operations. That is, in some embodiments, the controller 112 can include circuitry and/or can be configured to perform instructions to control movement of data and/or addresses associated with data such as among the buffer 114, the cache 116, and/or the first memory device 118 or the second memory device 120.

In an example, at least one of the processor 110 and the controller 112 comprises a command manager (CM) for the memory system 104. The CM can receive, such as from the host device 102, a read command for a particular logic row address in the first memory device 118 or the second memory device 120. In some examples, the CM can determine that the logical row address is associated with a first row based at least in part on a pointer stored in a register of the controller 112. In an example, the CM can receive from the host device 102, a write command for a logical row address, and the write command can be associated with second data. In some examples, the CM can be configured to issue, to non-volatile memory and between issuing the read command and the write command, an access command associated with the first memory device 118 or the second memory device 120. In some examples, the CM can issue, to the non-volatile memory and between issuing the read command and the write command, an access command associated with the first memory device 118 or the second memory device 120.

In an example, the buffer 114 comprises a data buffer circuit that includes a region of a physical memory used to temporarily store data, for example, while the data is moved from one place to another. The buffer 114 can include a first-in, first-out (FIFO) buffer in which the oldest (e.g., the first-in) data is processed first. In various embodiments, the buffer 114 includes a hardware shift register, a circular buffer, or a list.

In an example, the cache 116 comprises a region of a physical memory used to temporarily store particular data that is likely to be used again. The cache 116 can include a pool of data entries. In some examples, the cache 116 can be configured to operate according to a write-back policy in which data is written to the cache without being concurrently written to the first memory device 118. Accordingly, in some embodiments, data written to the cache 116 may not have a corresponding data entry in the first memory device 118.

In an example, the controller 112 can receive write requests (e.g., from the host device 102) involving the cache 116 and cause data associated with each of the write requests to be written to the cache 116. In some examples, the controller 112 can receive the write requests at a rate of thirty-two (32) gigatransfers (GT) per second, such as according to or using a CXL protocol. The controller 112 can similarly receive read requests and cause data stored in, e.g., the first memory device 118 or the second memory device 120, to be retrieved and written to, for example, the host device 102 via an interface 106.

In an example, the interface 106 can include any type of communication path, bus, or the like that allows information to be transferred between the host device 102 and the memory system 104. Non-limiting examples of interfaces can include a peripheral component interconnect (PCI) interface, a peripheral component interconnect express (PCIe) interface, a serial advanced technology attachment (SATA) interface, and/or a miniature serial advanced technology attachment (mSATA) interface, among others. In an example, the interface 106 includes a PCIe 5.0 interface that is compliant with the compute express link (CXL) protocol standard. Accordingly, in some embodiments, the interface 106 supports transfer speeds of at least 32 GT/s.

As similarly described elsewhere herein, CXL is a high-speed central processing unit (CPU)-to-device or CPU-to-memory interconnect designed to enhance compute performance. CXL technology maintains memory coherency between a CPU memory space (e.g., the host memory 108) and memory on attached devices or accelerators (e.g., the first memory device 118 or the second memory device 120), which allows resource sharing for higher performance, reduced software stack complexity, and lower overall system cost. CXL is designed to be an industry open standard interface for high-speed communications as accelerators are increasingly used to complement CPUs in support of emerging data-rich and compute-intensive applications such as artificial intelligence and machine learning.

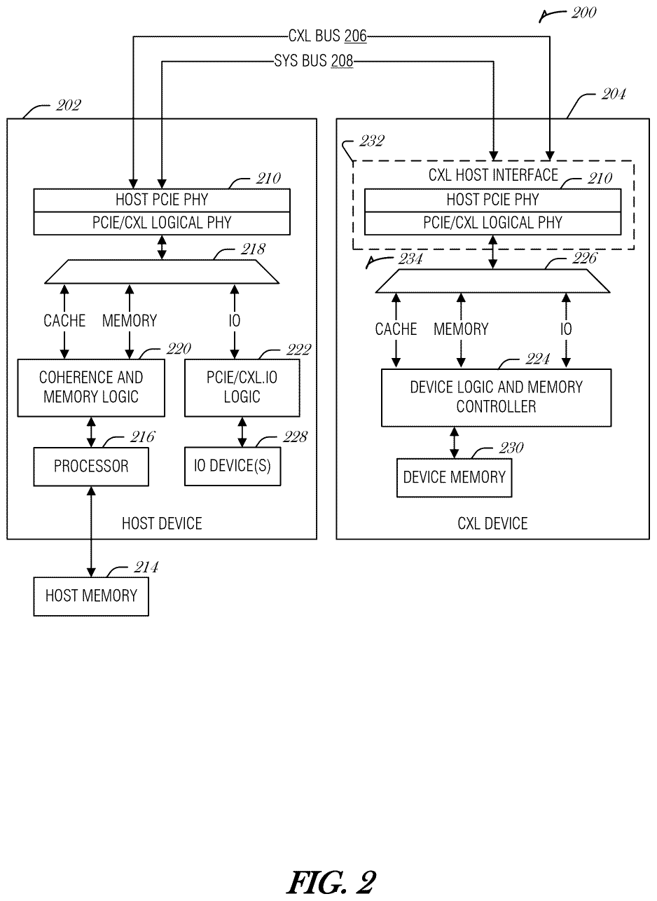

FIG. 2 is a block diagram illustrating an example of a CXL system 200 that uses a bus system, including a CXL link bus 206 and a system management bus (SMBus) 208, to connect a host device 202 and a CXL device 204, according to an embodiment. In an example, the host device 202 comprises or corresponds to the host device 102 and the CXL device 204 comprises or corresponds to the memory system 104 from the example of the computing system 100 in FIG. 1. A memory system command manager (CM) can comprise a portion of the host device 202 or the CXL device 204.

In an example, the SMBus 208 (e.g., corresponding to a portion of the interface 106 from the example of FIG. 1) is configured to support main-band or sideband communications between the host device 202 and the CXL device 204. The SMBus 208 can carry miscellaneous commands or events using PCIe and CXL protocols, such as link speed changes, reset commands issued by the host, firmware updates, and other reliability, availability, and serviceability features.

In an example, the CXL link bus 206 (e.g., corresponding to a portion of the interface 106 from the example of FIG. 1) can support communications using multiplexed protocols for caching (e.g., CXL.cache), memory accesses (e.g., CXL.mem or CXL.memory), and data input/output transactions (e.g., CXL.io). CXL.io can include a protocol based on PCIe that is used for functions such as device discovery, configuration, initialization, I/O virtualization, and direct memory access (DMA) using non-coherent load-store, producer-consumer semantics. CXL.cache can enable a device to cache data from the host memory (e.g., from the host memory 214) using a request and response protocol. CXL.memory can enable the host device 202 to use memory attached to the CXL device 204, for example, in or using a virtualized memory space. The CXL-based memory device can include or use a volatile or non-volatile memory such that it can be characterized by different speeds or latencies. In an example, the CXL-based memory device can include a CXL-based memory controller configured to manage transactions with the volatile or non-volatile memory.

In an example, CXL.memory transactions can be memory load and store operations that run downstream from or outside of the host device 202. CXL memory devices can have different levels of complexity. For example, a simple CXL memory system can include a CXL device that includes, or is coupled to, a single media controller, such as a memory controller (MEMC). A moderate CXL memory system can include a CXL device that includes, or is coupled to, multiple media controllers. A complex CXL memory system can include a CXL device that includes, or is coupled to, a cache controller (and its attendant cache) and to one or more media or memory controllers.

In the example of FIG. 2, the host device 202 includes a host processor 216 (e.g., comprising one or more CPUs or cores) and IO device(s) 228. The host device 202 can comprise, or can be coupled to, host memory 214. The host device 202 can include various circuitry or logic configured to facilitate CXL-based communications and transactions with the CXL device 204. For example, the host device 202 can include coherence and memory logic 220 configured to implement transactions according to CXL.cache and CXL.memory semantics, and the host device 202 can include PCIe logic 222 configured to implement transactions according to CXL.io semantics. In an example, the host device 202 can be configured to manage coherency of data cached at the CXL device 204 using, e.g., its coherence and memory logic 220.

The host device 202 can further include a host multiplexer 218 configured to modulate communications over the CXL link bus 206 (e.g., using the PCIe PHY layer). The multiplexing of protocols ensures that latency-sensitive protocols (e.g., CXL.cache and CXL.memory) have the same or similar latency as a native processor-to-processor link. In an example, CXL defines an upper bound on response times for latency-sensitive protocols to help ensure that device performance is not adversely impacted by variation in latency between different devices implementing coherency and memory semantics.

In an example, symmetric cache coherency protocols can be difficult to implement between host processors because different architectures may use different solutions, which in turn can compromise backward compatibility. CXL can address this problem by consolidating the coherency function at the host device 202, such as using the coherence and memory logic 220.

The CXL device 204 can include various components or logical blocks including a CXL host interface 232 and a device management system 234. In an example, the CXL host interface 232 can be configured to receive and manage various requests and transactions. For example, the CXL host interface 232 can be configured to receive and communicate PCIe resets such as using PERST (PCI Express Reset), Hot Reset, FLR (function level reset), and CXL resets. In an example, the CXL host interface 232 can be configured to receive and communicate DOE Transaction layer packets. In an example, the CXL host interface 232 can be configured to handle sideband requests or other miscellaneous events from PCIe and CXL devices, such as using the CXL link bus 206 or the system management bus 208.

The CXL host interface 232 can include or use multiple CXL interface physical layers 212. The device management system 234 can include, among other things, the device logic and memory controller 224. In an example, the CXL device 204 can comprise a device memory 230, or can be coupled to another memory device. The CXL device 204 can include various circuitry or logic configured to facilitate CXL-based communications and transactions with the host device 202 using the CXL link bus 206. For example, the device logic and memory controller 224 can be configured to implement transactions received using the CXL host interface 232 according to CXL.cache, CXL.memory, and CXL.io semantics. The CXL device 204 can include a CXL device multiplexer 226 configured to control communications over the CXL link bus 206.

In an example, one or more of the coherence and memory logic 220, the device management system 234, and the device logic and memory controller 224 comprises a Unified Assist Engine (UAE) or compute fabric with various functional units such as a command manager (CM), Threading Engine (TE), Streaming Engine (SE), Data Manager or data mover (DM), Advanced Encryption Standard (AES) engine, or other units. The compute fabric can be reconfigurable and can include separate synchronous and asynchronous flows.

The device management system 234 or the device logic and memory controller 224 or portions thereof can be configured to operate in an application space of the CXL system 200 and, in some examples, can initiate its own threads or sub-threads, which can operate in parallel and can optionally use resources or units on other CXL devices 204. Queue and transaction control through the system can be coordinated by the CM, TE, SE, DM, or AES engine components of the UAE. In an example, each queue or thread can map to a different loop iteration to thereby support multi-dimensional loops. With the capability to initiate such nested loops, among other capabilities, the system can realize significant time savings and latency improvements for compute-intensive operations.

In an example, command fencing can be used to help maintain order throughout such operations, which can be performed locally or throughout a compute space of the device logic and memory controller 224. In some examples, the CM can be used to route commands to a particular command execution unit (e.g., comprising the device logic and memory controller 224 of a particular instance of the CXL device 204) using an unordered interconnect that provides respective transaction identifiers (TID) to command and response message pairs.

In an example, the CM can coordinate a synchronous flow, such as using an asynchronous fabric of the reconfigurable compute fabric to communicate with other synchronous flows and/or other components of the reconfigurable compute fabric using asynchronous messages. For example, the CM can receive an asynchronous message from a dispatch interface and/or from another flow controller instructing a new thread at or using a synchronous flow. The dispatch interface may interface between the reconfigurable compute fabric and other system components. In some examples, a synchronous flow may send an asynchronous message to the dispatch interface to indicate completion of a thread.

Asynchronous messages can be used by synchronous flows such as to access memory. For example, the reconfigurable compute fabric can include one or more memory interfaces. Memory interfaces are hardware components that can be used by a synchronous flow or components thereof to access an external memory that is not part of the synchronous flow but is accessible to the host device 202 or the CXL device 204. A thread executed using a synchronous flow can include sending a read and/or write request to a memory interface. Because reads and writes are asynchronous, the thread that initiates a read or write request to the memory interface may not receive the results of the request. Instead, the results of a read or write request can be provided to a different thread executed at a different synchronous flow. Delay and output registers in one or more of the CXL devices 204 can help coordinate and maximize efficiency of a first flow, for example, by precisely timing engagement of particular compute resources of one device with arrival of data relevant to the first flow. The registers can help enable the particular compute resources of the same resource to be repurposed for flows other than the first flow, for example while the first flow dwells or waits for other data or operations to complete. Such other data or operations can depend on one or more other resources of the fabric.

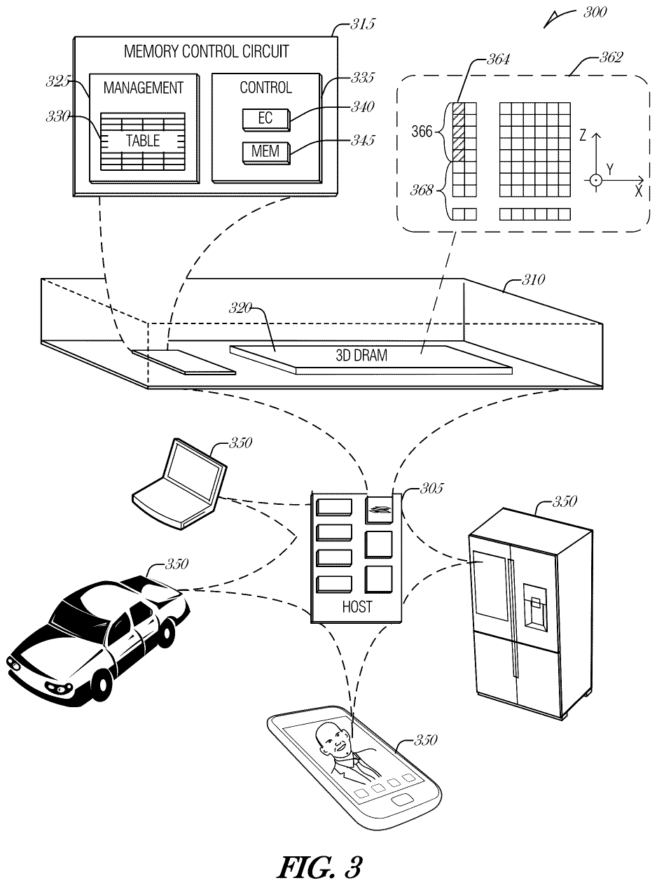

FIG. 3 illustrates an example of an environment 300 including a host device 305 and a memory device 310 configured to communicate over a communication interface, according to an embodiment. A product 350 may incorporate or integrate the host device 305 and the memory device 310. The product 350 may include such things as Internet of Things (IoT) devices (e.g., a refrigerator or other appliance, sensor, motor, or actuator, etc.), a mobile communication device, an automobile, a drone, a computers (e.g., laptop computers, desktop computers, or the like), or the like.

The memory device 310 includes a memory control circuit 315 and a memory array 320 including, for example, one or more individual memory dies (e.g., one or more 3D DRAM arrays). In 3D architecture semiconductor memory technology, vertical structures are stacked, increasing the number of tiers, physical pages, and accordingly, the density of a memory device (e.g., a storage device). In an example, the memory device 310 can be a discrete memory or storage device component of the host device 305. In other examples, the memory device 310 can be a portion of an integrated circuit (e.g., system on a chip (SOC), etc.), stacked or otherwise included with one or more other components of the host device 305.

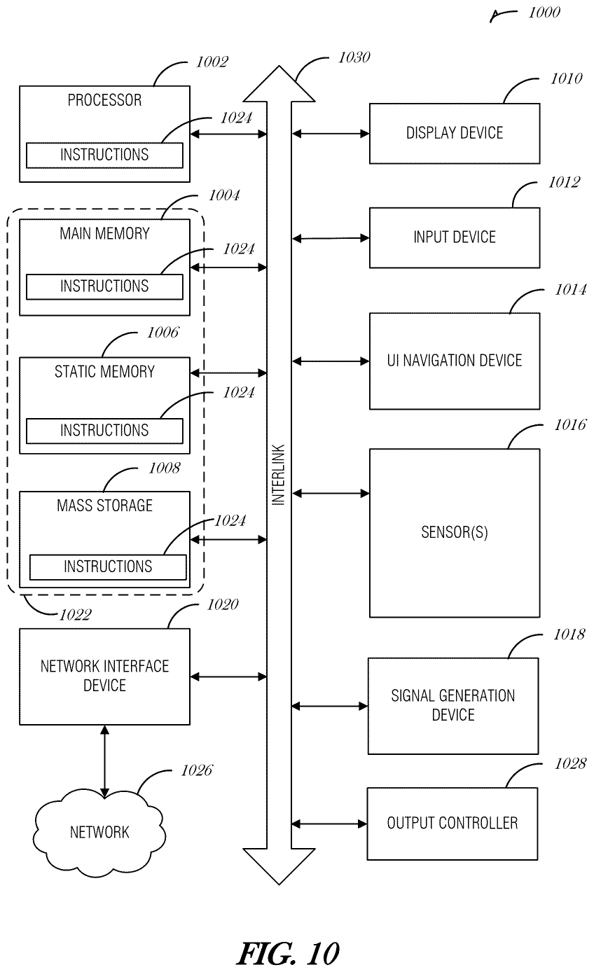

One or more communication interfaces can be used to transfer data between the memory device 310 and one or more other components of the host device 305. Interfaces may include, for example, a Serial Advanced Technology Attachment (SATA) interface, a Peripheral Component Interconnect Express (PCIe) interface, a Universal Serial Bus (USB) interface, a Universal Flash Storage (UFS) interface, an eMMC™ interface, or one or more other connectors or interfaces. The host device 305 can include a host system, an electronic device, a processor, a memory card reader, or one or more other electronic devices separate from the memory device 310. In some examples, the host device 305 may be a machine having some portion, or all, of the components discussed in reference to the machine 1000 of FIG. 10.

Electronic devices, such as mobile electronic devices (e.g., smart phones, tablets, etc.), devices for use in automotive applications (e.g., automotive sensors, control units, driver-assistance systems, passenger safety or comfort systems, etc.), and internet-connected appliances or devices (e.g., IoT devices, etc.), have varying storage needs depending on, among other things, the type of electronic device, use environment, performance expectations, etc.

Electronic devices can be broken down into several main components: a processor (e.g., a central processing unit (CPU) or other main processor); memory (e.g., one or more volatile or non-volatile RAM memory device, such as DRAM, mobile or low-power double-data-rate synchronous DRAM (DDR SDRAM), etc.); and a storage device (e.g., non-volatile memory (NVM) device, such as flash memory, ROM, an SSD, an MMC, or other memory card structure or assembly, etc.). In certain examples, electronic devices can include a user interface (e.g., a display, touch-screen, keyboard, one or more buttons, etc.), a graphics processing unit (GPU), a power management circuit, a baseband processor, or one or more transceiver circuits, etc.

The memory control circuit 315 can receive instructions from the host device 305, and can communicate with the memory array 320, such as to transfer data to (e.g., write or erase) or from (e.g., read) one or more of the memory cells, planes, sub-blocks, blocks, or pages of the memory array 320. The memory control circuit 315 can include, among other things, circuitry, or firmware, including one or more components or integrated circuits. For example, the memory control circuit 315 can include one or more memory control units, circuits, or components configured to control access across the memory array 320 and to provide a translation layer between the host device 305 and the memory device 310. The memory control circuit 315 can include one or more input/output (I/O) circuits, lines, or interfaces to transfer data to or from the memory array 320. The memory control circuit 315 can include a memory manager 325 and an array controller 335.

The memory manager 325 can include, among other things, circuitry or firmware, such as a number of components or integrated circuits associated with various memory management functions. For purposes of the present description, example memory operation and management functions are described in the context of DRAM memory. Persons skilled in the art will recognize that other forms of non-volatile memory may have analogous memory operations or management functions. Such DRAM management functions include memory cell refresh, error detection or correction, or one or more other memory management functions. The memory manager 325 can parse or format host commands (e.g., commands received from a host) into device commands (e.g., commands associated with operation of a memory array, etc.), or generate device commands (e.g., to accomplish various memory management functions) for the array controller 335 or one or more other components of the memory device 310.

The memory manager 325 can include a set of management tables 330 configured to maintain various information associated with one or more components of the memory device 310 (e.g., various information associated with a memory array, one or more memory cells coupled to the memory control circuit 315, or one or more memory devices in the memory control circuit 315). For example, the management tables 330 can include information regarding one or more error counts (e.g., a write operation error count, a read bit error count, a read operation error count, an erase error count, etc.) for one or more portions of the memory cells coupled to the memory control circuit 315.

The array controller 335 can include, among other things, circuitry or components configured to control memory operations associated with writing data to, reading data from, or erasing one or more memory cells of the memory device 310 coupled to the memory control circuit 315. The memory operations can be based on, for example, host commands received from the host device 305, or internally generated by the memory manager 325 (e.g., in association with refreshing, error detection or correction, etc.).

The array controller 335 can include an error correction circuit 340. In some examples, the error correction circuit 340 is arranged to implement error correction code (ECC) or another suitable error correction algorithm. For example, when data is to be written to a page or other subunit of memory cells of the memory array 320, the error correction circuit 340 may generate one or more parity bits based on the data. The parity bits are written to one or more memory cells at the memory array 320, for example, in a parity column association with the data. When data is read from the memory array 320, the data and its associated one or more parity bits are provided to the error correction circuit 340. The error correction circuit 340 may use the parity bits to, if possible, detect and correct any bit errors that may have occurred. In some examples, the error correction circuit 340 may be implemented in software that is executed by a processor, a microcontroller, or other suitable hardware at the memory control circuit 315.

The array controller 335 can include a memory device 345. The memory device 345 may be an SRAM device, in an embodiment. The memory device 345 can be used to store information related to data stored in the memory array 320. For instance, the memory device 345 may be used to store column redundancy data for one or more rows, or one or more pages, in the memory array 320. The memory device 345 may store the column redundancy date in place of, or in addition to, the data stored in the memory array 320. Other types of data may be stored in the memory device 345, such as parity data (ECC data), PRAC data, or the like. Additionally, the memory device 345 may be configured to store more than one type of data. For example, the memory device 345 may store parity data and GCR data for one or more pages of the memory array 320.

The memory array 320 can include memory cells arranged in, for example, a number of devices, planes, sub-blocks, blocks, or pages. In some examples, the memory array 320 may be arranged in three dimensions physically or logically. For example, memory cells in the memory array 320 may be arranged in rows, columns, and pages, as described herein. In some examples, data is written to or read from the memory array 320 in pages. Each page may comprise a memory cell corresponding to a combination of rows and columns, as described herein. In some examples, one or more memory operations (e.g., read, write, erase, etc.) can be performed on larger or smaller groups of memory cells, as desired.

A page of data can include a number of bytes of user data (e.g., a data payload including a number of sectors of data) and its corresponding metadata. A size of the page can refer to the number of bytes used to store the user data. As an example, a page of data can have a page size of 328 bits of user data (e.g., 8 columns of 8 bits) as well as a number of bytes (e.g., 32 B, 54 B, 224 B, etc.) of metadata corresponding to the user data, such as integrity data (e.g., error detecting or correcting code data), address data (e.g., logical address data, etc.), or other metadata associated with the user data.

Different types of memory cells or memory arrays can provide for different page sizes, or may use different amounts of metadata associated therewith. For example, different memory device types may have different bit error rates, which can lead to different amounts of metadata to ensure integrity of the page of data (e.g., a memory device with a higher bit error rate may use more bytes of parity data than a memory device with a lower bit error rate).

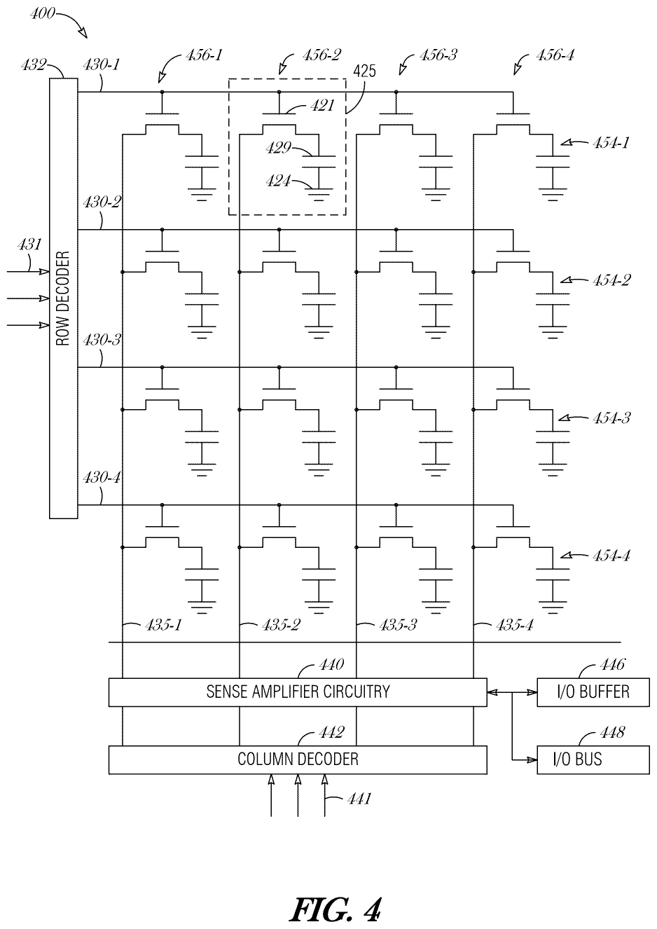

FIG. 4 is a schematic of an electrical arrangement of components of an embodiment of an example DRAM device 400, according to an embodiment. In an example, each of the memory cells 425 includes a GAA transistor 421 coupled to a capacitor 429. In some examples, the arrangement of FIG. 4 illustrates a page of memory cells 425. The memory cells 425 can be coupled to bit lines (BLs) 435, where each of the BLs 435 may be wrapped on a sidewall of an active area of the GAA transistor 421 of each memory cell 425 to which the BL 435 is coupled. Each word line (WL) 430 can be structured contacting gates of GAA transistors 421 of memory cells 425 to which the given WL 430 is coupled. The DRAM device 400 can include an array of memory cells 425 (only one being labeled in FIG. 4 for ease of presentation) arranged in rows 454-1, 454-2, 454-3, and 454-4 and columns 456-1, 456-2, 456-3, and 456-4. The physical orientation of the rows and columns is not shown. Further, while only four rows 454-1, 454-2, 454-3, and 454-4 and four columns 456-1, 456-2, 456-3, and 456-4 of memory cells are illustrated, DRAM devices, like DRAM device 400, can have significantly more memory cells 425 (for example, tens, hundreds, or thousands of memory cells) per row or per column.

In this example, each memory cell 425 can include a single transistor 421 and a single capacitor 429, which is commonly referred to as a 1T1C (one-transistor—one capacitor cell). One plate of capacitor 429, which can be termed the “node plate,” is connected to the drain terminal of transistor 421, whereas the other plate of the capacitor 429 is connected to ground 424 or other reference node. Each capacitor 429 within the array of 1T1C memory cells 425 typically serves to store one bit of data, and the respective transistor 421 serves as an access device to write to or read from storage capacitor 429.

The transistor gate terminals within each row of rows 454-1, 454-2, 454-3, and 454-4 are portions of respective WLs 430-1, 430-2, 430-3, and 430-4, and the transistor source terminals within each of columns 456-1, 456-2, 456-3, and 456-4 are electrically connected to respective BLs 435-1, 435-2, 435-3, and 435-4. A row decoder 432 can selectively drive the individual WLs 430-1, 430-2, 430-3, and 430-4, responsive to row address signals 431 input to row decoder 432. Driving a given WL 430 at a high voltage causes the access transistors within the respective row to conduct, thereby connecting the storage capacitors 429 within the row to the respective BLs 435, such that charge can be transferred between the BLs 435 and the storage capacitors 429 for read or write operations. Both read and write operations can be performed via SA circuitry 440, which can transfer bit values between memory cells 425 of the selected row of the rows 454-1, 454-2, 454-3, and 454-4 and input/output buffers 446 (for write/read operations) or external input/output data buses 448.

A column decoder 442 responsive to column address signals 441 can select which of the memory cells 425 within the selected row is read out or written to. Alternatively, for read operations, the storage capacitors 429 within the selected row can be read out simultaneously and latched, and the column decoder 442 can then select which latch bits to connect to the output data bus 448. Since read-out of the storage capacitors destroys the stored information, the read operation is accompanied by a rewrite of the capacitor charge. Further, in between read/write operations, the capacitor charge is repeatedly refreshed to prevent data loss.

DRAM device 400 can be implemented as an IC within a package that includes pins for receiving supply voltages (for example, to provide the source and gate voltages for the transistors 421) and signals (including data, address, and control signals). FIG. 4 depicts DRAM device 400 in simplified form to illustrate basic structural components, omitting many details of the memory cells 425 and associated WLs 430-1, 430-2, 430-3, and 430-4 and BLs 435-1, 435-2, 435-3, and 435-4 as well as the peripheral circuitry. For example, in addition to the row decoder 432, column decoder 442, Sense Amplifier (SA) circuitry 440, and buffers 446, DRAM device 400 can include further peripheral circuitry, such as a memory control circuit (e.g., the memory control circuit 115). The memory control circuit may control the memory operations based on control signals (provided, for example, by a host device, an external processor, etc.), additional input/output circuitry, or other features associated with a memory device. The peripheral circuitry can be located above the array of memory cells 425 in a CMOS over array (CoA) architecture using a wafer-on-wafer interconnect architecture. Alternatively, the peripheral circuitry can be located under the array of memory cells 425 in a CMOS under array (CuA) architecture. Alternatively, the peripheral circuitry can be located in a region of the IC of the memory device adjacent to an array region having the array of memory cells 425.

In two-dimensional (2D) DRAM arrays, the rows 454-1, 454-2, 454-3, and 454-4 and columns 456-1, 456-2, 456-3, and 456-4 of memory cells 425 can be arranged along a single horizontal plane (i.e., a plane parallel to the layers) of the semiconductor substrate, for example, in a rectangular lattice with WLs 430-1, 430-2, 430-3, and 430-4 and BLs 435-1, 435-2, 435-3, and 435-4. In three-dimensional (3D) DRAM arrays, the memory cells 425 can be arranged in a 3D lattice with a page of memory cells and associated WLs and BLs at a level above another page of memory cells and their associated WLs and BLs.

FIG. 4 is a diagram illustrating a memory device 400, according to an embodiment. In the example of FIG. 4, memory cells are arranged in three dimensions according to columns and rows positioned parallel to the X-Y plane and pages extending in the direction of the Z-axis. In the example illustrated in FIG. 4, rows of memory cells may extend into and/or out of the page in the direction of the Y-axis. Also, in the example of FIG. 4, columns 402-1, 402-2, 402-3, 402-4, . . . , 402-N, 412, and 416 are shown. It will be appreciated, however, that memory arrays as described herein may include more or fewer columns than are shown.

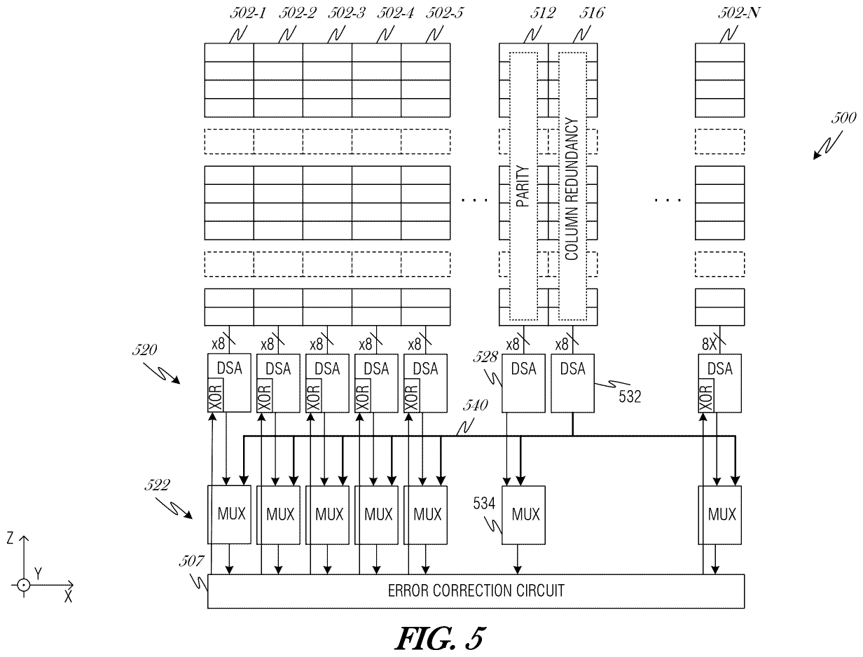

FIG. 5 shows an example of sensing circuitry for the respective columns including differential sense amplifiers (DSA) 520 and multiplexers (MUXs) 522, according to an embodiment. An error correction circuit 507 is also provided. In the example of FIG. 5, columns 502-1, 502-2, 502-3, 502-4, 502-5, 502-6 are data columns including memory cells that store payload data. For each data column 502, a respective differential sense amplifier (DSA) 520 may receive a column output sensed from the memory cells of the column and provide the column output to respective MUX 522. The MUXs 522 associated with data columns 502 may receive, in this example, two inputs. A first input may be received from the DSA 520 associated with the data column 502. A second input may be received from a column redundancy bus 540. The MUXs 522 may be configured, for example, by a control circuit (e.g., the memory control circuit 115), to provide a selected one of the inputs to the error correction circuit 507.

In the example of FIG. 5, the memory device 500 includes a column redundancy column 516 (e.g., GCR data). Sensing circuitry for the column redundancy column 516 may include a differential sense amplifier (DSA) 532. The DSA 532 may be configured to provide a column output read from the column redundancy column 516 to the column redundancy bus 540. In this way, if one of the data columns 502 is found to be defective, for example, during or after fabrication, then the particular MUX 522 associated with the defective data column 502 may be configured to pass the content of the column redundancy bus 540 to the data input of the error correction circuit 507. In this way, the column redundancy column 516 may act as a substitute for the defective data column 502.

The memory device 500 includes a parity column 512 that stores parity data. For example, the parity column 512 may store eight bits of parity data for each page. In examples in which there are eight data columns, this may come to a single parity bit for each data column. Sensing circuitry for the parity column 512 may comprise a differential sense amplifier (DSA) 528 and a MUX 534.

The MUX 534 may have two inputs. A first input may receive the column output of the parity column 512 provided by the differential sense amplifier (DSA) 528. A second input may receive the column redundancy bus 540. The MUX 534 may be configured to direct either the column output of the parity column 512 (from the DSA 528), or the column redundancy bus 540 to the error correction circuit 507. In this way, if the parity column 512 is determined to be defective, then a column redundancy column, such as column 516, may be used to store parity data.

In implementations that do not include a column redundancy column 516, the column output from the parity column 512 is directed to the error correction circuit 507. If the error correction circuit 507 detects a mismatch between the column output from the parity column 512 and a checksum that is computed based on the column outputs from the data columns, then a correction can be made to address a single bit error.

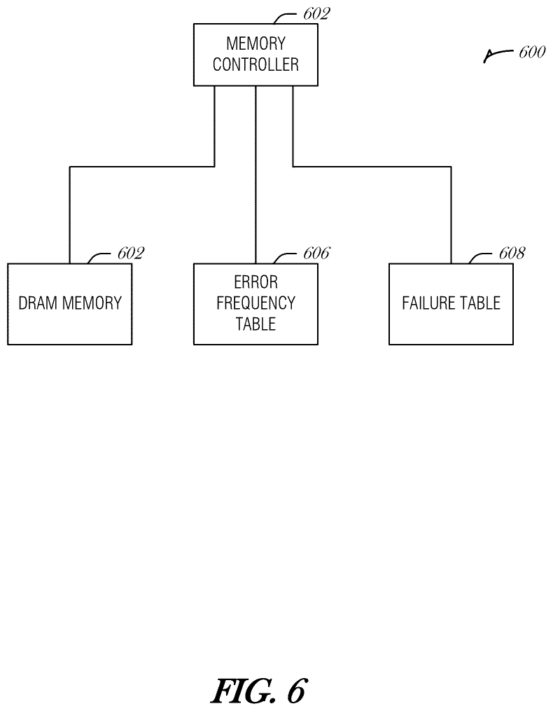

FIG. 6 is a block diagram illustrating a system architecture for error correction on a CXL device 600, according to an embodiment. A CXL memory controller 602 is connected to a memory device 604 (e.g., DRAM memory), an error frequency table 606, and a failure table 608. The CXL memory controller 602 may be an instance of device logic and memory controller 224 of FIG. 2. The memory device 604 may be an instance of device memory 230 of FIG. 2. The error frequency table 606 and failure table 608 may be stored in a memory device that is accessible by the CXL memory controller 602 and not accessible by a host processor or other off-board logic.

Patrol scrubbing is a memory scrubbing technique that automatically checks for errors in a computer's memory while it is idle. The CXL memory controller 602 reads memory locations at a specified frequency, corrects any errors, and writes the correct data back to the memory. The purpose of patrol scrubbing is to access every addressable location in the memory module to check for errors. The CXL memory controller 602 can be configured to periodically perform a patrol scrub for memory error evaluation, for instance, at regular intervals (e.g., every twenty-four hours, during low utilization times, etc.).

A test mode is utilized by the CXL memory controller 602 to disable on-die error correction and obtain data from the memory device 604 as it exists in the memory cells of the memory device 604 (e.g., uncorrected). This uncorrected, “raw” data is then analyzed by the CXL memory controller 602 to obtain failure data about one or more cells in the memory device 604. Corrected data may be written back to the memory device 604, or alternatively, defective data may be left in place to be corrected (if possible) by the on-die error correction circuitry during the next read of the data. There are two implementations discussed here.

In a first implementation, the CXL memory controller 602 disables the on-die error correction to enter test mode. This pauses normal memory traffic. The CXL memory controller 602 may assert a command to disable ECC on DRAM, such as tmfxDisEccCorrection. Use of this command sets a load mode register (LMR) with a value to indicate that the memory device 604 is running in test mode. When the LMR is set, the memory device 604 does not perform error correction and passes data values directly to the column output lines.

One or more rows of the memory device 604 are read by the CXL memory controller 602 while in test mode. The CXL memory controller 602 inspects that parity data for each row read, and creates an entry in the error frequency table 606. Each entry includes an indication of which row was affected by an error and an indication of the number of errors found. Entries may include other information, such as the die, bank, or other location indicia of the memory cell(s) experiencing failure or errors. Entries may also be timestamped or include other data to assist in detecting, tracking, or diagnosing hardware failures. The error frequency table 606 may be implemented using volatile or non-volatile memory. In an embodiment, the error frequency table 606 is implemented using NOR memory. Failure data (also referred to as “fail data”) includes at least a die identifier and row identifier for each entry in the error frequency table 606. In some embodiments, only those rows that have errors are stored in the error frequency table 606. Rows that are error free may be ignored.

The CXL memory controller 602 updates the failure table 608 to create or update rows that have the highest counts. The failure table 608 may be sorted from highest to lowest failure counts per row, and re-sorted after updates based on changes to the error frequency table 606. In an embodiment, the error frequency table 606 is implemented using a relatively slow storage type (e.g., NOR memory) and the failure table 608 is implemented using a relatively fast storage type (e.g., SRAM memory). Further, the error frequency table 606 is unordered data and the failure table 608 is maintained in an ordered state. This provides the CXL memory controller 602 easy access to the highest risk entries, in order to prioritize remedial operations. The failure table 608 is not limited to non-volatile memory. The failure table may be stored in SRAM, custom logic, or volatile memory that is dynamically loaded by the host.

Remedial operations include, but are not limited to, post package repair, off-lining pages of memory, alerting hardware, software, or humans about errors, and the like. Remedial operations may be triggered using one or more failure thresholds. For instance, after a row has experienced five or more single-bit or multi-bit errors, then a post package repair operation is initiated. As another example, if the row has experienced twenty or more errors, then the corresponding page may be offlined. Similarly, if the row has experienced 100 or more errors, then an alert signal may be transmitted to the host indicating a failure condition of the CXL device. The failure table 608 may also store statistics for groups of rows. For example, if there are multiple row addresses with high counts, the group of rows can trigger the page offlining. Or in the case of many rows with fails, an alert signal may be generated. The logic using the failure table 608 is not limited to a single row.

Any time after the error frequency table 606 is updated, the CXL memory controller 602 can unlatch the LMR (e.g., reset it to a normal run state) and allow normal memory traffic to resume. This may be performed immediately after the row is read to minimize downtime of the memory, or it may be performed after CXL memory controller 602 has completed error processing (e.g., after the failure table 608 update).

The error logging performed by the first implementation may be performed on a die-by-die basis, bank-by-bank basis, or other structured manner. For instance, a Die 0 may be latched into test mode, then inspected, and then unlatched to resume normal operation before Die 1 is latched, inspected, and released. This may continue for all dies in a bank, all dies on a memory module, or the like.

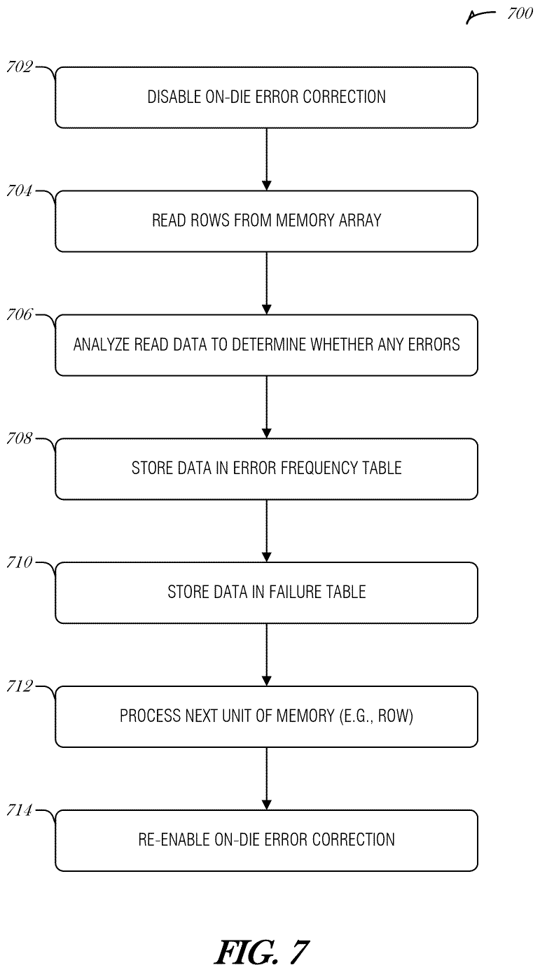

FIG. 7 is a flowchart illustrating a method 700 for fail logging of a memory array, according to an embodiment. At 702, a memory controller disables on-die error correction of one or more dies on a memory device. The memory controller may assert a command to set a value that is latched in an LMR, which controls whether error correction is enabled.

At 704, one or more rows are read from one or more memory arrays of one or more dies. For example, a row of memory cells are read with the row including data values and parity values for the data values. The parity values may include column parity values and/or row parity values.

At 706, the data values for the row are analyzed in view of the parity values to determine whether there are any errors in the row data values. In an embodiment, a column parity and a row parity are used to determine a single bit error (SBE) in the row's data values. In another embodiment a Reed-Solomon code is used to identify multiple bit errors in a row.

If errors are found, then at 708, data is stored in an error frequency table. The data may include a die index and a row index, along with a number of errors detected in the row data values. Other data may be stored in the error frequency table, such as a copy of the parity values, an indication of which memory cell of the row failed, a timestamp of when the scrub was performed or when the error was logged, etc. These entries may be stored in the error frequency table using a first-in-first-out (FIFO) mechanism, such that the oldest entries are removed or overwritten.

At 710, a failure table is updated using the error values that were stored in the error frequency table. The error frequency table is scanned, and unique rows are identified (e.g., unique row and die combinations). Errors for the die/row combination are summed and the totals are stored in the failure table. The entries in the failure table are sorted with those having the most failures at the top of the table.

If there are no errors found, or after completing the processing of errors in the previous row in operations 708 and 710, then at 712, the next unit of memory is processed. If a single row at a time is being read out and processed, then at 712, the next row is read from the die being checked. The rows may be processed in batches (e.g., 10 row batch, 20 row batch, etc.). After the row or rows are processed and the error checking stage is completed, then at 714, the value in the LMR is unlatched and normal memory traffic can resume.

Returning to the discussion of FIG. 6, in a second implementation, instead of latching the LMR for error logging of each memory unit (e.g., die), a test mode “context” is set using the LMR. While the CXL device is executing in the test mode context, two read operations are recognized and allowed: a normal read operation and a read operation with ECC disabled (e.g., an ECCOFF_READ). In this manner, the test mode context may be set at the beginning of error logging, and it may be left on for the entirety of the time used to inspect the memory module, during which other normal read operations may take place. A new command, ECCOFF_READ is implemented that is similar to a standard read command, but uses additional column address (CA) bits to disable the DSA flip of the ECC logic and output non-corrected data to the column outputs. In an embodiment, CA bit 10, 10, or 11 is used to control whether ECC is active. Using a test mode context over multiple error logging operations, instead of latching LMR on individual error logging operations, reduces latency due to latching/unlatching.

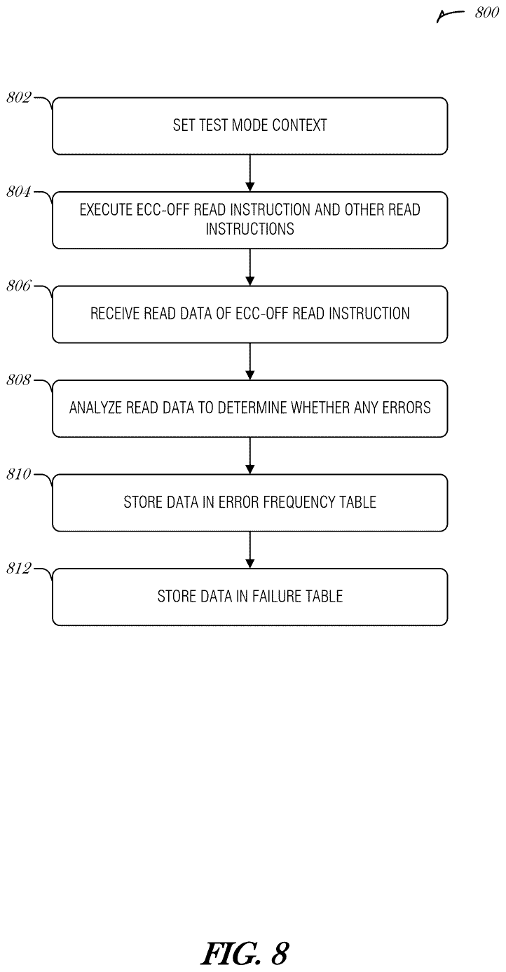

FIG. 8 is a flowchart illustrating a method 800 for fail logging of a memory array, according to an embodiment. At 802, a test mode context is set by latching a value in an LMR. The test mode context allows for a separate read instruction that disables on-die ECC.

At 804, read instructions including an ECC-off read instruction is executed by the memory controller. The ECC-off read instruction causes the on-die circuitry to bypass the on-die ECC and return the row data values uncorrected. The ECC-off read instruction may use the same format as a regular read operation but with additional flags in an unused portion of the regular read operation. For example, previously-unused column address bits may be used as a flag to the on-die circuitry to disable ECC for that read operation. The ECC-off read instructions are inserted into the memory pipeline and are executed with regular read operations.

At 806, the memory controller receives the results of an ECC-off read operation, which includes a row's data values and parity values. The parity values may include column parity values and/or row parity values.

At 808, the data values for the row are analyzed in view of the parity values to determine whether there are any errors in the row data values. In an embodiment, a column parity and a row parity are used to determine a single bit error (SBE) in the row's data values. In another embodiment a Reed-Solomon code is used to identify multiple bit errors in a row.

If errors are found, then at 810, data is stored in an error frequency table. The data may include a die index and a row index, along with a number of errors detected in the row data values. Other data may be stored in the error frequency table, such as a copy of the parity values, an indication of which memory cell of the row failed, a timestamp of when the scrub was performed or when the error was logged, etc. This entries may be stored in the error frequency table using a first-in-first-out (FIFO) mechanism, such that the oldest entries are removed or overwritten.

At 812, a failure table is updated using the error values that were stored in the error frequency table. The error frequency table is scanned, and unique rows are identified (e.g., unique row and die combinations). Errors for the die/row combination are summed and the totals are stored in the failure table. The entries in the failure table are sorted with those having the most failures at the top of the table.

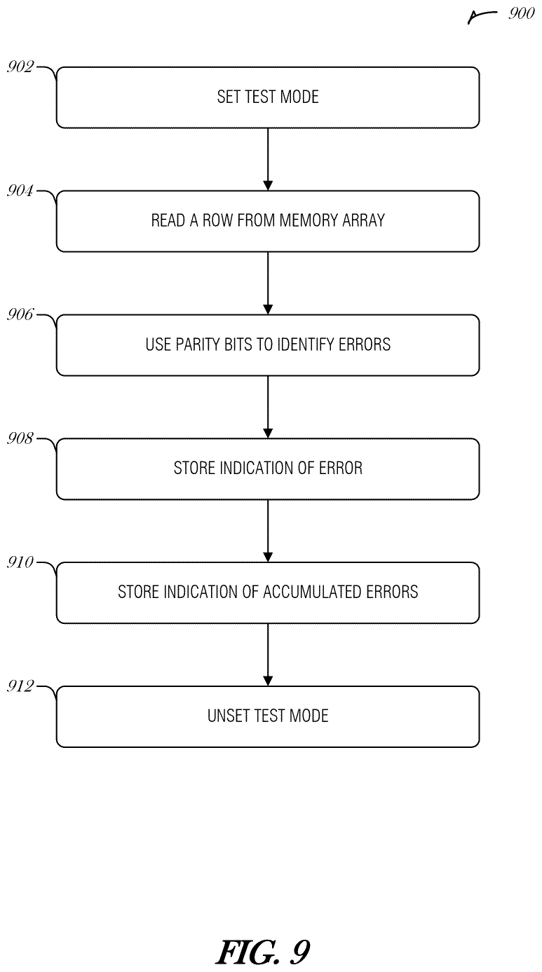

FIG. 9 is a flowchart illustrating an example method 900 for collecting fail data, according to an embodiment. The method 900 can be performed by processing logic that can include hardware (e.g., processing device, circuitry, dedicated logic, programmable logic, microcode, hardware of a device, integrated circuit, etc.). In various embodiments, the method 900 is performed by the controller 112 of FIG. 1, device logic and memory controller 224 of FIG. 2, or the hardware processor 1002 of FIG. 10.

At 902, the method 900 includes the operations of setting a test mode in a random access memory device. In an embodiment, setting the test mode includes setting a register to disable on-die error correction at the random access memory device.

At 904, the method 900 includes the operations of reading a row from a memory array of the random access memory device, the row including data bits and parity bits. In an embodiment, reading from the memory array of the random access memory device includes setting a register to enable a special read instruction that reads uncorrected data from the random access memory device.

At 906, the method 900 includes the operations of using the parity bits to identify an error in the data bits.

At 908, the method 900 includes the operations of storing an indication of the error in a first non-volatile memory. In an embodiment, storing the indication of the error in the first non-volatile memory includes storing a die index corresponding to a die on the random access memory device that includes the memory array, a row index of the row from the memory array, and a number of errors identified in the row. In a further embodiment, storing the indication of the error in the first non-volatile memory includes storing, in the first non-volatile memory, a timestamp of when the number of errors were identified.

At 910, the method 900 includes the operations of storing an indication of accumulated errors in a second memory. In an embodiment, the method 900 includes scanning the first non-volatile memory to identify unique combinations of die and row indexes, aggregating a counter value for each unique combination of die and row index, and storing the counter value for a particular combination of die and row index in the second memory. In a further embodiment, the method 900 includes storing the counter value for the particular die and row index in the second memory when the counter value exceeds a threshold value. In a further embodiment, the method 900 includes sorting the second memory from a highest counter value to a lowest counter value.

At 912, the method 900 includes the operations of unsetting the test mode.

In an embodiment, the method 900 includes initiating a remedial operation. In a further embodiment, the remedial operation includes at least one of: post package repair or offlining a memory page.

FIG. 10 illustrates a block diagram of an example machine 1000 with which, in which, or by which any one or more of the techniques (e.g., methodologies) discussed herein can be implemented. Examples, as described herein, can include, or can operate by, logic or a number of components, or mechanisms in the machine 1000. Circuitry (e.g., processing circuitry) is a collection of circuits implemented in tangible entities of the machine 1000 that include hardware (e.g., simple circuits, gates, logic, etc.). Circuitry membership can be flexible over time. Circuitries include members that can, alone or in combination, perform specified operations when operating. In an example, hardware of the circuitry can be immutably designed to carry out a specific operation (e.g., hardwired). In an example, the hardware of the circuitry can include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time. Additional examples of these components with respect to the machine 1000.

In alternative embodiments, the machine 1000 can operate as a standalone device or can be connected (e.g., networked) to other machines. In a networked deployment, the machine 1000 can operate in the capacity of a server machine, a client machine, or both in server-client network environments. In an example, the machine 1000 can act as a peer machine in peer-to-peer (P2P) (or other distributed) network environment. The machine 1000 can be a personal computer (PC), a tablet PC, a set-top box (STB), a personal digital assistant (PDA), a mobile telephone, a web appliance, a network router, switch or bridge, embedded memory controller, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine 1000 (e.g., computer system) can include a hardware processor 1002 (e.g., a central processing unit (CPU), a graphics processing unit (GPU), a hardware processor core, or any combination thereof), a main memory 1004, a static memory 1006 (e.g., memory or storage for firmware, microcode, a basic-input-output (BIOS), unified extensible firmware interface (UEFI), etc.), and mass storage device 1008 (e.g., hard drives, tape drives, flash storage, or other block devices) some or all of which can communicate with each other via an interlink 1030 (e.g., bus). The machine 1000 can further include a display device 1010, an alphanumeric input device 1012 (e.g., a keyboard), and a user interface (UI) Navigation device 1014 (e.g., a mouse). In an example, the display device 1010, the input device 1012, and the UI navigation device 1014 can be a touch screen display. The machine 1000 can additionally include a mass storage device 1008 (e.g., a drive unit), a signal generation device 1018 (e.g., a speaker), a network interface device 1020, and one or more sensor(s) 1016, such as a global positioning system (GPS) sensor, compass, accelerometer, or other sensor. The machine 1000 can include an output controller 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the hardware processor 1002, the main memory 1004, the static memory 1006, or the mass storage device 1008 can be, or include, a machine-readable media 1022 on which is stored one or more sets of data structures or instructions 1024 (e.g., software) embodying or used by any one or more of the techniques or functions described herein. The instructions 1024 can also reside, completely or at least partially, within any of registers of the hardware processor 1002, the main memory 1004, the static memory 1006, or the mass storage device 1008 during execution thereof by the machine 1000. In an example, one or any combination of the hardware processor 1002, the main memory 1004, the static memory 1006, or the mass storage device 1008 can constitute the machine-readable media 1022. While the machine-readable media 1022 is illustrated as a single medium, the term “machine-readable medium” can include a single medium or multiple media (e.g., a centralized or distributed database, or associated caches and servers) configured to store the one or more instructions 1024.

The term “machine readable medium” can include any medium that is capable of storing, encoding, or carrying instructions for execution by the machine 1000 and that cause the machine 1000 to perform any one or more of the techniques of the present disclosure, or that is capable of storing, encoding, or carrying data structures used by or associated with such instructions. Non-limiting machine-readable medium examples can include solid-state memories, optical media, magnetic media, and signals (e.g., radio frequency signals, other photon-based signals, sound signals, etc.). In an example, a non-transitory machine-readable medium comprises a machine-readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media can include: non-volatile memory, such as semiconductor memory devices (e.g., electrically programmable read-only memory (EPROM), electrically erasable programmable read-only memory (EEPROM)) and flash memory devices; magnetic disks, such as internal hard disks and removable disks; magneto-optical disks; and CD-ROM and DVD-ROM disks.

In an example, information stored or otherwise provided on the machine-readable media 1022 can be representative of the instructions 1024, such as instructions 1024 themselves or a format from which the instructions 1024 can be derived. This format from which the instructions 1024 can be derived can include source code, encoded instructions (e.g., in compressed or encrypted form), packaged instructions (e.g., split into multiple packages), or the like. The information representative of the instructions 1024 in the machine-readable media 1022 can be processed by processing circuitry into the instructions to implement any of the operations discussed herein. For example, deriving the instructions 1024 from the information (e.g., processing by the processing circuitry) can include: compiling (e.g., from source code, object code, etc.), interpreting, loading, organizing (e.g., dynamically, or statically linking), encoding, decoding, encrypting, unencrypting, packaging, unpackaging, or otherwise manipulating the information into the instructions 1024.

In an example, the derivation of the instructions 1024 can include assembly, compilation, or interpretation of the information (e.g., by the processing circuitry) to create the instructions 1024 from some intermediate or preprocessed format provided by the machine-readable media 1022. The information, when provided in multiple parts, can be combined, unpacked, and modified to create the instructions 1024. For example, the information can be in multiple compressed source code packages (or object code, or binary executable code, etc.) on one or several remote servers. The source code packages can be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 1024 can be further transmitted or received over a communications network 1026 using a transmission medium via the network interface device 1020 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), plain old telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 1020 can include one or more physical jacks (e.g., Ethernet, coaxial, or phone jacks) or one or more antennas to connect to the network 1026. In an example, the network interface device 1020 can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1000, and includes digital or analog communications signals or other intangible medium to facilitate communication of such software. A transmission medium is a machine readable medium.

To better illustrate the methods and apparatuses described herein, a non-limiting set of Example embodiments are set forth below as numerically identified Examples.

Example 1 is a memory system comprising: a first non-volatile memory to store error data; a second memory to store failure data; a random access memory device; and controller circuitry configured to: set a test mode in the random access memory device; read a row from a memory array of the random access memory device, the row including data bits and parity bits; use the parity bits to identify an error in the data bits; store an indication of the error in the first non-volatile memory; and store an indication of accumulated errors in the second memory.

In Example 2, the subject matter of Example 1 includes, wherein to set the test mode, the controller circuitry is configured to set a register to disable on-die error correction at the random access memory device.

In Example 3, the subject matter of Examples 1-2 includes, wherein to read from the memory array of the random access memory device, the controller circuitry is configured to set a register to enable a special read instruction that reads uncorrected data from the random access memory device.

In Example 4, the subject matter of Examples 1-3 includes, wherein to store the indication of the error in the first non-volatile memory, the controller circuitry is configured to: store a die index corresponding to a die on the random access memory device that includes the memory array, a row index of the row from the memory array, and a number of errors identified in the row.

In Example 5, the subject matter of Example 4 includes, wherein to store the indication of the error in the first non-volatile memory, the controller circuitry is configured to: store, in the first non-volatile memory, a timestamp of when the number of errors were identified.

In Example 6, the subject matter of Examples 1-5 includes, wherein the controller circuitry is configured to: scan the first non-volatile memory to identify unique combinations of die and row indexes; aggregate a counter value for each unique combination of die and row index; and store the counter value for a particular combination of die and row index in the second memory.

In Example 7, the subject matter of Example 6 includes, wherein the controller circuitry is configured to store the counter value for the particular die and row index in the second memory when the counter value exceeds a threshold value.

In Example 8, the subject matter of Example 7 includes, wherein the controller circuitry is configured to sort the second memory from a highest counter value to a lowest counter value.

In Example 9, the subject matter of Examples 1-8 includes, wherein the controller circuitry is configured to initiate a remedial operation.

In Example 10, the subject matter of Example 9 includes, wherein the remedial operation includes at least one of: post package repair or offlining a memory page.

In Example 11, the subject matter of Examples 1-10 includes, wherein the controller circuitry is configured to unset the test mode after reading a row from the memory array.

Example 12 is a method performed by a memory controller comprising: setting a test mode in a random access memory device; reading a row from a memory array of the random access memory device, the row including data bits and parity bits; using the parity bits to identify an error in the data bits; storing an indication of the error in a first non-volatile memory; storing an indication of accumulated errors in a second memory; and unsetting the test mode.

In Example 13, the subject matter of Example 12 includes, setting the test mode comprises setting a register to disable on-die error correction at the random access memory device.

In Example 14, the subject matter of Examples 12-13 includes, wherein reading from the memory array of the random access memory device comprises setting a register to enable a special read instruction that reads uncorrected data from the random access memory device.

In Example 15, the subject matter of Examples 12-14 includes, wherein storing the indication of the error in the first non-volatile memory comprises storing a die index corresponding to a die on the random access memory device that includes the memory array, a row index of the row from the memory array, and a number of errors identified in the row.

In Example 16, the subject matter of Example 15 includes, wherein storing the indication of the error in the first non-volatile memory comprises storing, in the first non-volatile memory, a timestamp of when the number of errors were identified.

In Example 17, the subject matter of Examples 12-16 includes, scanning the first non-volatile memory to identify unique combinations of die and row indexes; aggregating a counter value for each unique combination of die and row index; and storing the counter value for a particular combination of die and row index in the second memory.

In Example 18, the subject matter of Example 17 includes, storing the counter value for the particular die and row index in the second memory when the counter value exceeds a threshold value.

In Example 19, the subject matter of Example 18 includes, sorting the second memory from a highest counter value to a lowest counter value.

In Example 20, the subject matter of Examples 12-19 includes, initiating a remedial operation.

In Example 21, the subject matter of Example 20 includes, wherein the remedial operation includes at least one of: post package repair or offlining a memory page.

Example 22 is a non-transitory machine-readable medium including instructions, which when executed by a memory controller of a memory system, cause the memory controller to: set a test mode in a random access memory device; read a row from a memory array of the random access memory device, the row including data bits and parity bits; use the parity bits to identify an error in the data bits; store an indication of the error in a first non-volatile memory; store an indication of accumulated errors in a second memory; and unset the test mode.

In Example 23, the subject matter of Example 22 includes, wherein to set the test mode, the instructions cause the memory controller to set a register to disable on-die error correction at the random access memory device.

In Example 24, the subject matter of Examples 22-23 includes, wherein to read from the memory array of the random access memory device, the instructions cause the memory controller to set a register to enable a special read instruction that reads uncorrected data from the random access memory device.

In Example 25, the subject matter of Examples 22-24 includes, wherein to store the indication of the error in the first non-volatile memory, the instructions cause the memory controller to store a die index corresponding to a die on the random access memory device that includes the memory array, a row index of the row from the memory array, and a number of errors identified in the row.

In Example 26, the subject matter of Example 25 includes, wherein to store the indication of the error in the first non-volatile memory, the instructions cause the memory controller to store, in the first non-volatile memory, a timestamp of when the number of errors were identified.

In Example 27, the subject matter of Examples 22-26 includes, wherein the instructions cause the memory controller to: scan the first non-volatile memory to identify unique combinations of die and row indexes; aggregate a counter value for each unique combination of die and row index; and store the counter value for a particular combination of die and row index in the second memory.

In Example 28, the subject matter of Example 27 includes, wherein the instructions cause the memory controller to store the counter value for the particular die and row index in the second memory when the counter value exceeds a threshold value.

In Example 29, the subject matter of Example 28 includes, wherein the instructions cause the memory controller to sort the second memory from a highest counter value to a lowest counter value.

In Example 30, the subject matter of Examples 22-29 includes, wherein the instructions cause the memory controller to initiate a remedial operation.

In Example 31, the subject matter of Example 30 includes, wherein the remedial operation includes at least one of: post package repair or offlining a memory page.

Example 32 is at least one machine-readable medium including instructions that, when executed by processing circuitry, cause the processing circuitry to perform operations to implement of any of Examples 1-31.

Example 33 is an apparatus comprising means to implement of any of Examples 1-31.

Example 34 is a system to implement of any of Examples 1-31.

Example 35 is a method to implement of any of Examples 1-31.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” can include “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A memory system comprising:
a first non-volatile memory to store error data;
a second memory to store failure data;
a random access memory device; and
controller circuitry configured to:
set a test mode in the random access memory device;
read a row from a memory array of the random access memory device, the row including data bits and parity bits;
use the parity bits to identify an error in the data bits;
store an indication of the error in the first non-volatile memory; and
store an indication of accumulated errors in the second memory.

2. The memory system of claim 1, wherein to set the test mode, the controller circuitry is configured to set a register to disable on-die error correction at the random access memory device.

3. The memory system of claim 1, wherein to read from the memory array of the random access memory device, the controller circuitry is configured to set a register to enable a special read instruction that reads uncorrected data from the random access memory device.

4. The memory system of claim 1, wherein to store the indication of the error in the first non-volatile memory, the controller circuitry is configured to:
store a die index corresponding to a die on the random access memory device that includes the memory array, a row index of the row from the memory array, and a number of errors identified in the row.

5. The memory system of claim 4, wherein to store the indication of the error in the first non-volatile memory, the controller circuitry is configured to:
store, in the first non-volatile memory, a timestamp of when the number of errors were identified.

6. The memory system of claim 1, wherein the controller circuitry is configured to:
scan the first non-volatile memory to identify unique combinations of die and row indexes;
aggregate a counter value for each unique combination of die and row index; and
store the counter value for a particular combination of die and row index in the second memory.

7. The memory system of claim 6, wherein the controller circuitry is configured to store the counter value for the particular die and row index in the second memory when the counter value exceeds a threshold value.

8. The memory system of claim 7, wherein the controller circuitry is configured to sort the second memory from a highest counter value to a lowest counter value.

9. The memory system of claim 1, wherein the controller circuitry is configured to initiate a remedial operation.

10. The memory system of claim 9, wherein the remedial operation includes at least one of: post package repair or offlining a memory page.

11. The memory system of claim 1, wherein the controller circuitry is configured to unset the test mode after reading a row from the memory array.

12. A method performed by a memory controller, the method comprising:
setting a test mode in a random access memory device;
reading a row from a memory array of the random access memory device, the row including data bits and parity bits;
using the parity bits to identify an error in the data bits;
storing an indication of the error in a first non-volatile memory;
storing an indication of accumulated errors in a second memory; and
unsetting the test mode.

13. The method of claim 12, setting the test mode comprises setting a register to disable on-die error correction at the random access memory device.

14. The method of claim 12, wherein reading from the memory array of the random access memory device comprises setting a register to enable a special read instruction that reads uncorrected data from the random access memory device.

15. The method of claim 12, wherein storing the indication of the error in the first non-volatile memory comprises storing a die index corresponding to a die on the random access memory device that includes the memory array, a row index of the row from the memory array, and a number of errors identified in the row.

16. The method of claim 15, wherein storing the indication of the error in the first non-volatile memory comprises storing, in the first non-volatile memory, a timestamp of when the number of errors were identified.

17. The method of claim 12, comprising:
scanning the first non-volatile memory to identify unique combinations of die and row indexes;
aggregating a counter value for each unique combination of die and row index; and
storing the counter value for a particular combination of die and row index in the second memory.

18. The method of claim 17, comprising storing the counter value for the particular die and row index in the second memory when the counter value exceeds a threshold value.

19. The method of claim 18, comprising sorting the second memory from a highest counter value to a lowest counter value.

20. The method of claim 12, comprising initiating a remedial operation.
